(19) United States
(12) Patent Application Publication
(10) Pub. No.: US 2011/0035934 A1
(43) Pub. Date: Feb. 17, 2011

(54) Method for Producing an Individual Cell for a Battery

(75) Inventors: Jens Meintschel, Bernsdorf (DE); Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/918,598

(22) PCT Filed: Feb. 19, 2009
(86) PCT No.: PCT/EP2009/001171

§ 371 Date: Oct. 4, 2010

(30) Foreign Application Priority Data
Feb. 23, 2008 (DE) 10 2008 010 810.3

(51) Int. Cl. H01M 6/00

(52) U.S. Cl. 29/623.1

(57) ABSTRACT

In a method for producing an individual cell for a battery with an electrode stack arranged inside a cell housing formed by two electrically conductive housing side walls and an interposed, peripheral, electrically insulating frame, current drain tabs of each polarity are connected respectively to a corresponding pole contact of the electrode stack and an electrically conductive connection is produced between the pole contacts and the housing side walls. According to the invention, the electrically conductive connection is generated in an open state of the individual cell.

This application is a national stage of PCT International Application No. PCT/EP2009/001171, filed Feb. 19, 2009, which claims priority under 35 U.S.C. §119 to German Patent Application No. 10 2008 010 810.3, filed Feb. 23, 2008, the entire disclosure of which is herein expressly incorporated by reference.

### BACKGROUND AND SUMMARY OF THE INVENTION

The invention relates to a method for producing an individual cell for a battery.

According to the state of the art, high voltage batteries, e.g., lithium ion batteries, are known for vehicle uses, which are in particular constructed of several individual cells interconnected electrically in series or in parallel. With bipolar individual cells, the electrical contacts, that is, a plus and a minus pole, can thereby be placed directly on parts of the housing which are electrically insulated with regard to each other.

German patent document DE 10 2007 063 181.4 discloses an individual cell, in particular a flat cell, for a battery with an electrode stack arranged within the cell housing. The cell housing has two opposite housing side walls and an electrically insulating frame arranged between them. The electrical contacting of the electrode stack takes place directly to the housing side walls facing each other, in particular flat sides, of the cell housing. The contacting thereby takes place in a method for producing the individual cell in particular by means of full penetration welding of an associated outer side in an assembled state of the individual cell in order to contact the pole contacts of the electrode films lying in the inside towards the outside.

It is however disadvantageous that a heat input into the interior of the cell housing takes place during the welding process, which can damage or destroy the components arranged in the cell housing, as for example the electrode stack. Measures for protecting temperature-sensitive parts are therefore necessary, which lead to an increased material, time, and, resulting therefrom, to an increased cost effort.

German patent document DE 101 05 877 A1 discloses a lithium ion battery and a method for its production. The lithium ion battery comprises a housing with a front side, a rear side, an anode cell clamp and a cathode cell clamp separated from this. Several bipolar lithium ion cells with a polymer separator permeable for lithium ions are arranged in the housing, wherein the cell electrodes consist of a thin film plastic substrate and are suitably connected to the anode and cathode clamps in an electrical manner. The cells are arranged in the longitudinal direction in the housing parallel to the sides of the housing, wherein the housing is closed by the cathode cell clamp at one end and by the anode cell clamp at the opposite end of the cell sleeve. An electrolyte arranged between the cells can be filled into the closed housing, wherein the electrolyte is provided for a transport of ions between the anode and the cathode.

One object of the invention, therefore, is to provide an improved method for producing an individual cell.

This and other objects and advantages are achieved by the method according to the invention for producing an individual cell for a battery with an electrode stack arranged inside a cell housing. The cell housing is formed of two electrically conductive housing side walls and an interposed, peripheral and electrically insulating frame. Current drain tabs of one polarity are thereby respectively combined to a pole contact of the electrode stack, two material depressions electrically insulated from each other and spaced from each other are introduced into the frame, in which current drain tabs of the same polarity are inserted and an electrically conductive connection is generated between the pole contacts and the housing side walls. According to the invention, the electrically conductive connection is generated in an open state of the individual cell.

The open state is especially meant to be that the housing side walls are not fastened to the frame, wherein the electrode stack can be arranged in the frame.

By the arrangement of the electrode stack in the peripheral, in particular electrically insulating frame, an additional insulating arrangement can be saved in an advantageous manner. The manipulation of the individual cell is further eased or designed in a safer manner. By means of the electrically conductive connection of the pole contacts with the housing side walls in the open state of the individual cell according to the invention, there is the possibility of a belated control of the joining location. Furthermore, the pole contacts of the electrode stack can be guided from the inside of the individual cell to the outside without elaborate sealing measures by means of the suggested contacting.

In a further embodiment of the invention, a pole contact is connected to a housing side wall in an electrically conductive manner before arranging the electrode stack in the frame, which leads to a lower technical effort, as only the remaining pole contact has to be connected electrically to the associated housing side wall after arranging the electrode stack in the frame.

After arranging the electrode stack in the frame, at least the remaining pole contact is connected to the associated housing side wall in an electrically conductive manner. Alternatively, both pole contacts can also be connected to the housing side wall in an electrically conductive manner after arranging the electrode stack.

The generation of the electrically conductive connection of the pole contacts to the housing sides before and after arranging the electrode stack in the frame can in particular take place in particular in a welding method on the one hand, wherein one or several weld seams and/or weld spots are generated during the welding method. In a preferred manner, the housing side wall is partially melted on further in the depth of the current drain tabs forming the pole contact of the electrode stack, so that all current drain tabs forming the pole contacts and the corresponding electrically conductive housing side wall are welded to each other with a weld seam and/or a weld spot, in particular in one step. By means of the resulting form-fit connection, an electrically conductive connection with a low transfer resistance is generated, which has a high current capacity.

On the other hand, the electrically conductive connection of the housing side walls and of the pole contacts can be generated in a combined welding-press joining method (e.g., an ultrasound welding method). A safe joining process is achieved thereby in addition to the advantages of the welding process on the one hand by the pressing together, and on the other hand, a heat input into the electrode stack avoided or at least reduced by the ultrasound welding method.

In an advantageous continuation of the invention, a separate film for an additional material is introduced between the pole contacts and the housing side walls or is applied to the sides facing the pole contacts of the housing wall before generating the electrically conductive connection, so that the connection of the pole contacts to the housing side walls is improved.

The electrode stack is thereby formed by individual electrodes, preferably electrode films, wherein the electrodes are separated from each other in an insulating manner by means of a separator, preferably a separator film. A copper and/or an aluminum film or a film of such an alloy are chosen thereby as electrode film.

In a particular manner, an edge region of the respective electrode film guided to the outside of the electrode stack is used as current drain tab, whereby an elaborate contacting of the electrode film and the current drain tab is omitted. This type of contacting is at the same time very safe against at least many, in particular outer influences such as impacts or vibrations.

According to a sensible further development of the invention, the clear height of a material depression measured in the direction of the stacking of the electrodes is chosen smaller than or the same as the corresponding extension of the associated current drain tabs stacked above each other, and their depth measured parallel to the flat side of an electrode film is chosen larger than or the same as the corresponding extension of the associated extension of the associated current drain tabs. The current drain tabs are hereby held securely in the material depressions.

For ensuring the mechanical stability and a tightness of the individual cell with regard to a passage of foreign materials into the cell housing or of materials from the cell housing, the housing side walls are fastened to the frame in a force-fit, material-fit and/or form-fit manner in one arrangement of the invention after generating the electrically conductive connection, so that the individual cell can subsequently be filled with an electrolyte.

By means of the of one or more of the mentioned measures, it is possible to simplify the construction of a cell housing with a cost-efficient production, to increase the vibration safety and thus the stability, the durability and thereby again the multiplicity of usage. Furthermore, a control of the joining location is possible by the simple contacting at the open individual cell, so that in particular the reject during the production is also reduced. Furthermore, by means of the material-fit contacting of the current drain tabs for forming the pole contacts and the material-fit connection of thereof, the current capacity is improved. A weakening of the pressure tightness of the cell housing of the individual cell is also not present, as a contact passing of the poles does not take place.

Other objects, advantages and novel features of the present invention will become apparent from the following detailed description of the invention when considered in conjunction with the accompanying drawings.

### BRIEF DESCRIPTION OF THE DRAWINGS

FIG. 1 shows schematically an individual cell in an open state;

FIG. 2 shows schematically a device for carrying out a welding-press joining method;

FIG. 3 shows schematically a side view of the open individual cell according to FIG. 1 and an arrangement of the device for carrying out the welding-press joining method during a welding process;

FIG. 4 is a schematic perspective view of the open individual cell according to FIG. 1 and an arrangement of the device for carrying out the welding-press joining method during a welding process;

FIG. 5 is a schematic perspective view of an electrode stack during a welding process for generating an electrically conductive connection with a housing side wall by means of a device for carrying out a welding-press joining method; and

FIG. 6 is an enlargement of a section of FIG. 5.

### DETAILED DESCRIPTION OF THE DRAWINGS

Parts corresponding to each other are provided with the same reference numerals in all figures.

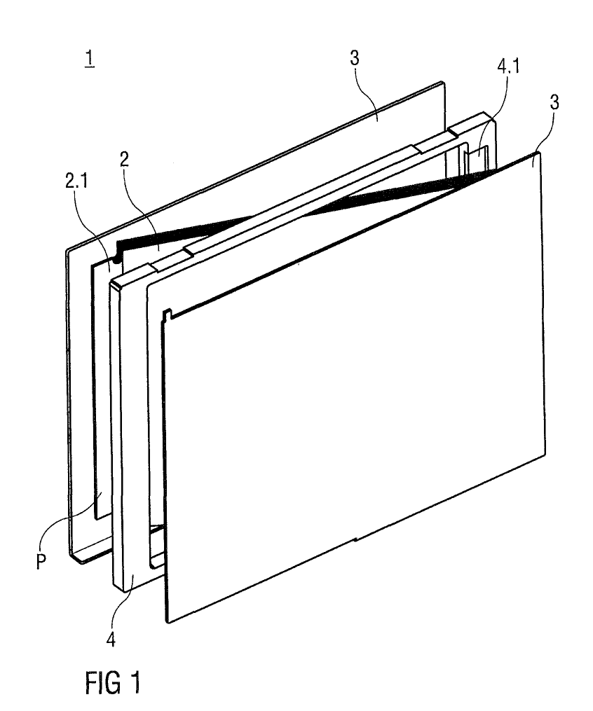

FIG. 1 is an exploded view of an individual cell 1 designed as a frame flat cell. It comprises an electrode stack 2 arranged in a cell housing, wherein the cell housing has two electrically conductive housing side walls 3, in particular flat sides, and an interposed peripheral and electrically insulating frame 4.

The electrode stack 2 is thereby formed in particular of electrode films (not shown in detail), wherein electrode films with different polarity, in particular aluminum and/or copper films and/or films of a metal alloy, are stacked above each other and are insulated electrically from each other by means of a separator, in particular a separator film (not shown in detail).

In an edge region of the electrode films projecting over the center region of the electrode stack 2, the current drain tabs 2.1, electrode films with the same polarity are connected to each other in an electrical manner.

The peripheral frame 4 surrounding the electrode stack 2 has two spaced material depressions 4.1 facing each other, which are thereby formed in such a manner that the pole contacts P formed of the current drain tabs 2.1 can be arranged in the material depressions 4.1. The clear height of the material depressions 4.1 is in particular formed in such a manner that it corresponds to or is smaller than the corresponding extension of the current drain tabs 2.1 which are stacked above each other in an uninfluenced manner. The depth of the material depressions 4.1 corresponds to the corresponding extension of the current drain tabs 2.1 or is formed larger than this.

By means of the electrically insulating embodiment of the frame 4, the pole contacts P formed of the current drain tabs 2.1 of different polarity are electrically insulated from each other in an advantageous manner, so that additional arrangements for an electrical insulation can be foregone in an advantageous manner.

According to the invention, an electrically conductive connection of the pole contacts P and of the housing side wall 3 is generated in the shown open state of the individual cell 1. The shown open state thereby in particular represents a state in which the housing side walls 3 are not fastened to the frame 4 and the electrode stack 2 is guided through the frame 4 or is arranged therein.

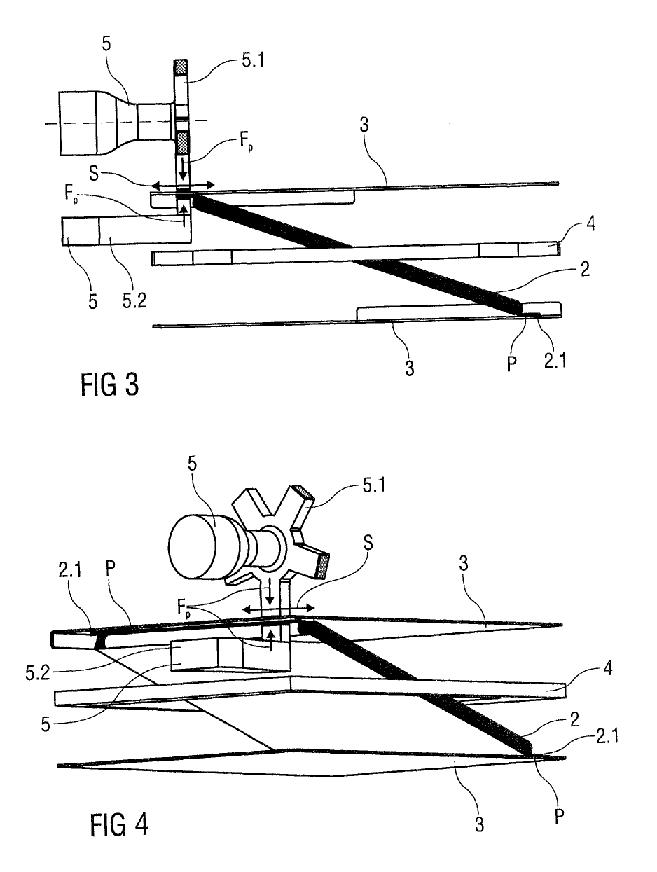

For generating this electrically conductive connection, the welding methods and/or welding-press joining methods are used in particular which are explained in more detail in FIGS. 3 to 6.

A material-fit, form-fit and/or force-fit fastening of the housing side walls 3 to the frame 4 takes place in a manner not shown in detail after generating the electrically conductive connection (e.g., by means of adhesion and/or connection elements), in order to achieve a high stability of the connection between the housing side walls 3 and the frame 4.

The connection elements are in particular rivets, tab-like extensions of the housing side wall 3 surrounding the frame at least in a peripheral manner and/or holding elements formed at the frame. For generating the form-fit and/or force-fit connection, the housing side walls 3 and/or the frame 4 preferably have forms or recesses, not shown in detail, corresponding to the respective connection elements.

From the material-fit, form-fit and/or force-fit fastening of the housing side walls 3 to the frame 4 results a tight embodiment of the cell housing in addition to the high stability, so that foreign materials cannot enter this. It is furthermore ensured that an electrolyte filled in after the fastening of the housing side wall 3 to the frame 4 cannot discharge and damages a surrounding field of the battery, not shown in detail, formed of the individual cells 1.

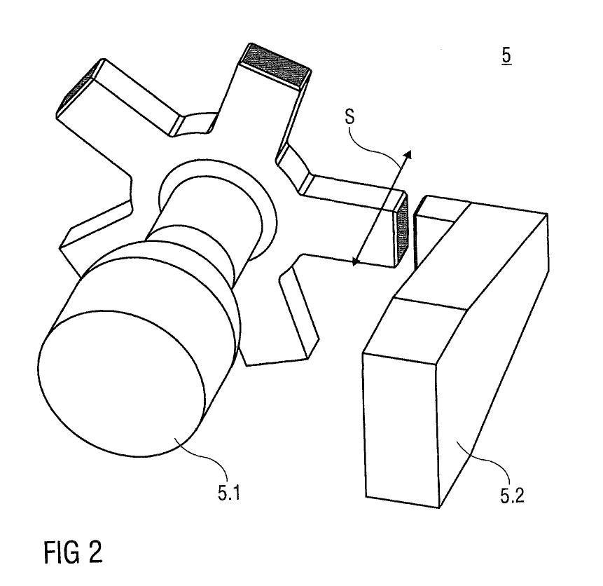

FIG. 2 shows a welding device 5 for carrying out a welding-press joining method. This welding device 5 is in particular an ultrasound welding device, which is formed by a sonotrode 5.1 and an anvil 5.2.

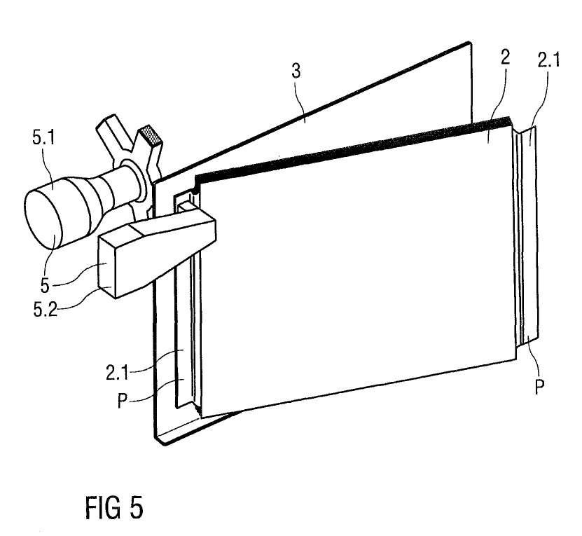

For the electrically conductive connection of the pole contacts P to the housing side walls 3, the electrode stack 2 is guided through the frame 3 according to FIGS. 3 and 4 and the current drain tabs 2.1 forming the pole contacts P are stacked one above the other and in a planar manner on the insides of the respective associated cell side walls 3. A relative bending of the current drain tabs 3.1 to the center region of the electrode stack 2 which is necessary thereby is achieved by the flexibility of the used electrode films.

For a welding of the current drain tabs 2.1 to the pole contacts P and for a simultaneous welding of this with the housing side walls 3, the pole contacts P lying on the insides of the housing side walls 3 and the housing side walls 3 are arranged between the sonotrode 5.1 and the anvil 5.2 and are pressed together by means of an introduced pressing force F_{P}. The sonotrode 5.1 simultaneously generates an oscillation S with a frequency in the ultrasound region, so that the pole contacts P and the housing side walls 3 are moved against each other with a large friction. By means of a large friction heat resulting thereby, a weld seam, not shown in detail, or a weld spot, not shown in detail, results thereby so that a material-fit and electrically conductive connection between the pole contacts P and the housing side walls 3 results.

A planar electrically conductive connection of the housing side walls 3 with the pole contacts P is especially achieved by several weld seams and/or weld spots arranged in series and/or in parallel.

In addition to the ultrasound welding method, alternative further welding-press joining methods known in the state of the art are suitable for the generation. This can for example be a condenser discharge welding, a resistance-press welding, an electrical spot welding or an electrical rolled seam welding.

According to a continuation of the invention, not shown in detail, the current drain tabs 2.1 are pressed together and/or welded to the housing side walls 3 to the pole contacts P in a separate method before generating the electrically conductive connection.

In a further arrangement of the invention, not shown in detail, a separate film, not shown in detail, which is e.g., made of nickel, can additionally be introduced between the pole contacts P, which are e.g., made of copper, and the housing side walls 3, which are e.g., made of aluminum, in order to achieve an improved connection between the pole contacts P and the housing side walls 3 during the welding process. This film can alternatively also be applied to the sides of the housing side walls 3 facing the pole contacts P.

In an advantageous further development of the invention, it is furthermore possible to arrange an electrically insulating film, not shown in detail, between the pole contacts and the housing side walls 3 or to design the housing side walls 3 on one side with an electrically insulating layer, so that an electrical contacting of the pole contacts P with the housing side walls 3 only occurs during the welding process. This insulating film or layer preferably further serves for protecting the housing side wall 3 from corrosion, for example caused by a contact with the electrolyte which is present in the individual cell 1.

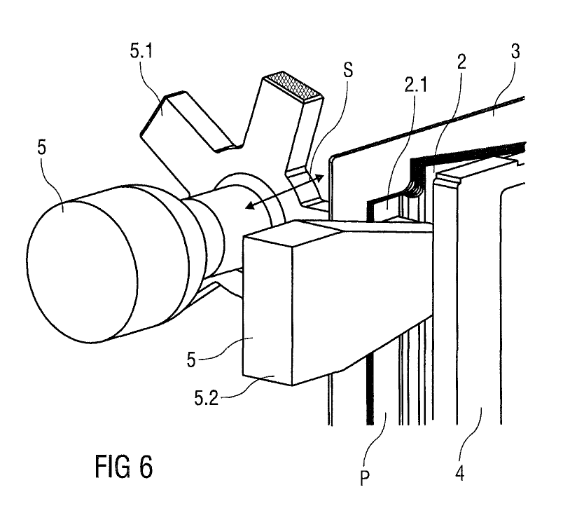

In FIGS. 5 and 6 is shown an advantageous arrangement of the invention by means of a perspective of the electrode stack 2 during a welding process for the electrically conductive connection to a housing side wall 3 by means of the welding device for carrying out the welding-press joining method.

Thereby, a pole contact P of the electrode stack 2 is connected to an associated cell side wall 3 in an electrically conductive manner in an open state of the individual cell 1, in which the electrode stack 2 is not yet guided through the frame 4 or is arranged therein, so that only the remaining pole contact P has to be connected in an electrically conductive manner to the other cell side wall 3 after guiding the electrode stack 2 through the frame 4. In particular by means of the simplified manipulation of the electrode stack resulting therefrom, a simplification of the production of the individual cell 1 is achieved.

For generating the electrically conductive connection, the welding-press joining methods further known from the state of the art can be used in addition to the shown ultrasound welding method. Welding methods with a high heat input, as for example a laser welding method, can also be used, as a good heat discharge is ensured with the shown arrangement and can be enlarged additionally by means of simple measures, not shown in detail.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Individual cell
2 Electrode stack
   2.1 Current drain tab
3 Housing side wall
4 Frame
   4.1 Material depression
5 Welding device
   5.1 Sonotrode
   5.2 Anvil
F_{P} pressing force
P Pole contact
S Oscillation

1-15. (canceled)

16. A method for producing an individual cell for a battery having an electrode stack arranged inside a cell housing formed by two electrically conductive housing side walls and an interposed, peripheral and electrically insulating frame, wherein:
current drain tabs of each polarity are respectively connected to a corresponding pole contact of the electrode stack;
two material depressions electrically insulated from each other and spaced from one another are formed in the frame;
current drain tabs are inserted into the respective material depressions of the same polarity;
an electrically conductive connection is made between the pole contacts and the housing side walls; and
the electrically conductive connection is generated in an open state of the individual cell.

17. The method according to claim 16, wherein one of said pole contacts is connected to one of said housing side walls in an electrically conductive manner, before arranging the electrode stack in the frame.

18. The method according to claim 16, wherein at least one pole contact is connected to one of said housing side walls in an electrically conductive manner, after arranging the electrode stack in the frame.

19. The method according to claim 16, wherein the electrically conductive connection of the housing side walls and of the pole contacts is formed by one of a welding method and a combined welding-press joining method.

20. The method according to claim 19, wherein at least one weld is generated during the welding method.

21. The method according to claim 19, wherein:
at least one weld is generated during the welding-press joining method; and
the pole contacts and the housing side walls are pressed together.

22. The method according to claim 20, wherein all current drain tabs forming the pole contacts and the corresponding electrically conductive housing side wall are welded to each other with one of a weld seam and a spot weld, in one step.

23. The method according to claim 16, wherein a separate film of an additional material is introduced between the pole contacts and the housing side walls before generating the electrically conductive connection.

24. The method according to claim 16, wherein a film of an additional material is applied to the sides of the housing side walls facing the pole contacts before the electrical connection is formed.

25. The method according to claim 16, wherein:
the electrode stack arranged in the cell housing is formed of individual electrode films; and
the electrodes are separated from each other in an insulating manner by means of a separator film.

26. The method according to claim 25, wherein an edge region of the respective electrode film guided to the outside of the electrode stack is used as current drain tab.

27. The method according to claim 26, wherein said electrode films comprise one of a copper film, an aluminum film and a film a copper/aluminum alloy.

28. The method according to claim 16, wherein a clear height of a material depression measured in a stacking direction of the electrode films is at least as small as the corresponding extension of the associated current drain tabs stacked above each other; and
depth of said depression measured parallel to the flat side of an electrode film is at least as large as a corresponding extension of the associated current drain tabs.

29. The method according to claim 16, wherein:
the housing side walls are fastened to the frame in a manner that is one of a force-fit, a material-fit and a form-fit after generating the electrically conductive connection; and
the individual cell is filled with an electrolyte.
